(19) United States
(12) Patent Application Publication
(10) Pub. No.: US 2018/0099737 A1
(43) Pub. Date: Apr. 12, 2018

(54) CONTROL DEVICE FOR AN AIRCRAFT

(71) Applicant: AIRBUS OPERATIONS LIMITED, Bristol (GB)

(72) Inventor: Philip WRIGHT, Bristol (GB)

(21) Appl. No.: 15/689,607

(22) Filed: Aug. 29, 2017

(30) Foreign Application Priority Data
Oct. 11, 2016 (GB) 1617259.5

(51) Int. Cl. B64C 9/26; B64C 13/30

(52) U.S. Cl. CPC B64C 9/26; B64C 3/28; B64C 13/30

(57) ABSTRACT

A control device (34) for an aircraft wing (3) including upper and lower spoilers (35, 37) mountable to a wing (3) behind a leading edge slat (26), wherein each of the upper and lower spoilers (35, 37) are movable in a direction towards each other into a wing (3) from a neutral position, to an enabled position to form an airflow slot (52) between the slat (26) and said upper and lower spoilers (35, 37). Each of the upper and lower spoilers (35, 37) may also be movable in a direction away from each other out of a wing (3) from said neutral position.

### RELATED APPLICATION

This application claims priority to and incorporates by reference United Kingdom (GB) patent application 1617259.5 filed Oct. 11, 2016.

### TECHNICAL FIELD

The present invention relates to a control device for an aircraft. The present invention also relates to a wing assembly comprising the control device, a wing for an aircraft comprising the wing assembly, and to an aircraft comprising the wing according to the invention.

### BACKGROUND

Aircraft must operate across a large flight envelope over which the wings need to create lift to keep the aircraft flying in a controlled manner at various airspeeds. Therefore, a wing having a single geometry is normally not sufficient for creating the required lift in, for example, landing and cruise without unacceptable disadvantages such as too much drag.

Therefore, aircraft wings are designed with control devices, such as slats, flaps, and spoilers, which can be moved to alter the characteristics of the wings to alter their lift coefficient so that the required amount of lift is created for a given airspeed.

More than one type of control device is often used and multiple units of the control devices can usually be found along the span of the leading edge of an aircraft wing. However, the systems for deploying such control devices are often complicated, heavy, and large resulting in a reduction in aircraft efficiency. Furthermore, in aircraft with wingtips that fold to make them compatible with airport gate width restrictions, it is difficult to provide multiple systems that extend across the fold.

### SUMMARY

According to the invention, there is provided a control device for an aircraft, the control device comprising upper and lower spoilers mountable to an aircraft wing behind a leading edge slat, wherein each of said upper and lower spoilers are movable in a direction towards each other into a wing from a neutral position to an enabled position to form an airflow slot between the slat and said upper and lower spoilers.

The upper and lower spoilers may be configured to allow the wing to operate at a higher angle of attack when said upper and lower spoilers are in their enabled position.

At least one of said upper and lower spoilers may be rotatable in a direction towards the other of said upper and lower spoilers from said neutral position to said enabled position.

In an embodiment, each of said upper and lower spoilers are configured so that they contact each other in their enabled position.

Each of said upper and lower spoilers may comprise a contact surface along which they make contact in their enabled position.

In an embodiment, each of said upper are lower spoilers are movable in a direction away from each other out of a wing from said neutral position to a deployed position.

The upper and lower spoilers may be configured to reduce lift created by a wing when said upper and lower spoilers are in their deployed position.

At least one of said upper and lower spoilers may rotatable in a direction away from the other of said upper and lower spoilers from said neutral position to said deployed position.

In an embodiment, the control device may further comprise an actuator assembly for driving each of said upper and lower spoilers.

The actuator assembly may be configured to drive both spoilers simultaneously.

According to another aspect of the invention, there is provided a wing assembly for an aircraft comprising a wing structure, a slat extending from a leading edge of said wing structure and a control device according to the invention mounted to the leading edge of said wing structure behind the slat.

The slat may be in a fixed in position.

In an embodiment, each of said upper and lower spoilers are pivotally mounted to the leading edge of said wing structure and extend in a direction towards the slat when in their neutral and deployed positions.

In an embodiment, the wing structure comprises an upper and lower surface and the upper spoiler lies flush with said surface in said neutral position.

The upper spoiler may extend below said upper surface in said enabled position.

In an embodiment, the lower spoiler lies flush with said lower surface in said neutral position.

The lower spoiler may extend above said lower surface in said enabled position.

According to yet another embodiment of the invention, there is provided an aircraft wing comprising a wing assembly according to the invention.

The wing may include an inboard portion and a foldable outboard portion being foldable relative to the inboard portion, and wherein the wing assembly is formed in the foldable outboard portion.

In another embodiment, the wing comprises an inboard portion and an outboard portion, the outboard portion being foldable relative to the inboard portion, and wherein the wing assembly is located in the inboard portion.

According to yet another aspect of the invention, there is provided an aircraft comprising a wing according to the invention.

### BRIEF DESCRIPTION OF THE DRAWINGS

Embodiments of the invention will now be described, by way of example only, with reference to the accompanying drawings, in which:

FIG. 1 shows a schematic perspective view of a known aircraft;

FIG. 2 shows a schematic front view of the aircraft shown in FIG. 1 with its outboard portions of a main wing in a folded position;

FIG. 3 shows a schematic cross-sectional view of a wing assembly comprising a control device in its neutral position;

FIG. 4 shows a schematic cross-sectional view of the wing assembly shown in FIG. 3 with the control device in its enabled position; and

FIG. 5 shows a schematic cross-sectional view of the wing assembly shown in FIG. 3 with the control device in its deployed position.

### DETAILED DESCRIPTION

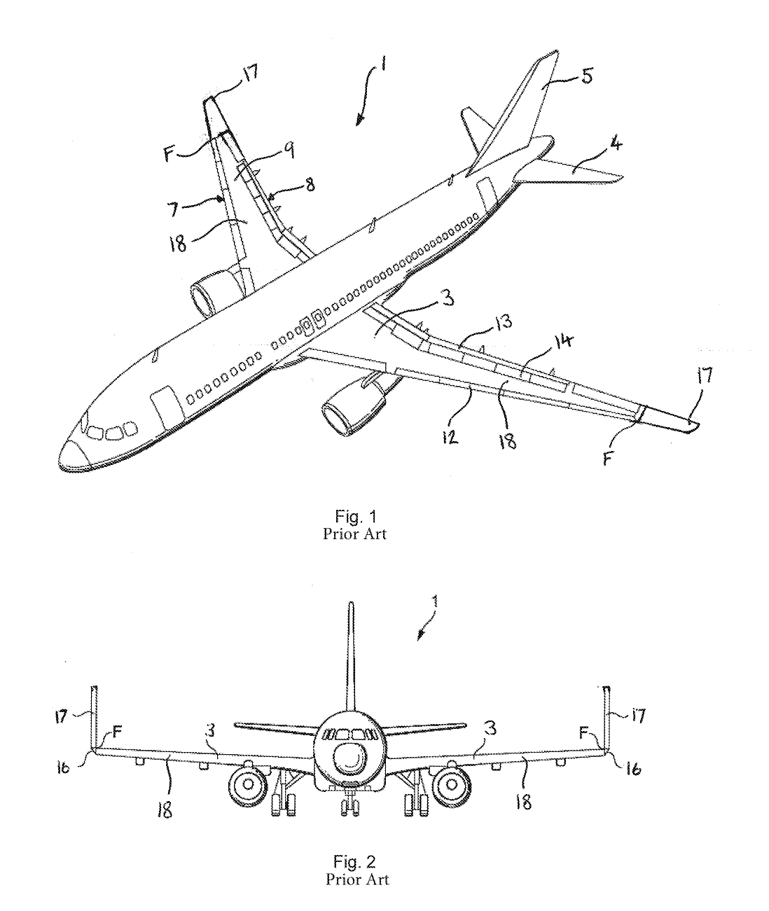

Referring to FIGS. 1 and 2, a commercial aircraft 1 of known configuration is shown. The aircraft 1 comprises a fuselage 2, main wings 3, tail planes 4, and a vertical tail 5 which all extends from the fuselage 2. It is known that one option for increasing the efficiency of the main wings 3 is to increase their aspect ratio. That is, the span of the main wings 3 may be increased in order to reduce drag while maintaining the lift characteristics of the wing 3.

The main wings 3 comprise an aerofoil shaped cross-section which tapers towards the extremities of the span. The aerofoil shaped main wings 3 comprise a leading edge 7 and a trailing edge 8 which are connected by an upper surface 9 and a lower surface (not shown in FIG. 1). During flight airflow is first influenced by the leading edge 7. Therefore, the leading edge 7 is the most upstream point of the main wings 3 and the trailing edge 8 is the furthest downstream point.

The main wings 3 further comprise movable control surfaces which are configured to vary the amount of lift generated. Lift devices such as slats 12 are provided along the leading edge 7 of the main wings 3. The slats 12 are configured to increase the critical angle of attack, which is the angle at which airflow detaches from the upper surface 9 of the main wings 3 when the slats 12 are deployed. Therefore, the aircraft 1 is able to fly at a high angle of attack which allows lift to be generated at a lower speed. The slats 12 are deployed when the aircraft 1 is flying at low speed, for example, during landing.

Flaps 13 are located along the trailing edge 8 and are configured to increase the camber of the main wings 3 which increase the lift coefficient of the main wings 3 when they are deployed. Spoilers 14 are located in the upper surface 9 and are configured to decrease the lift generated by the main wings 3 when they are deployed. Spoilers 14 are deployed during cruise to offload excess lift caused by gusts or manoeuvres and can be deployed after landing to decrease lift and increase drag.

When deployed, a spoiler 14 extends at an angle to the profile of the main wings 3 into the airflow over the main wing 3. The extension of the spoiler 14 into the airflow causes the flow behind the spoiler 14 to separate from the upper surface 9 of the section of the main wing 3 in which the spoiler 14 has been deployed. This causes a controlled stall over the portion of the main wing 3 downstream of the deployed spoiler 14 which greatly reduces, or ‘dumps’, the lift created by the section of the main wing 3 downstream of the spoiler 14.

The main wings 3 may further comprise a folding system 16, shown in FIG. 2, configured to fold an outboard portion 17 of the main wings 3 along a fold line (F) relative to an inboard portion 18 of the main wings 3. This allows the aircraft 1 with the enlarged wing span to access existing terminal gates.

However, this may mean that there are a number of control surfaces which are located on the outboard portion 17 on one side of the fold line (F). This means that complex systems must be developed to connect the outboard control surfaces to the inboard controls to enable their deployment. Furthermore, the weight of the main wings 3 is increased due to the control systems in the outboard portions and the presence of the folding system 16. An alternative is to have no control systems in the outboard portions 17, as depicted in FIG. 1 for simplicity, which can result in an amount of lift inconsistent with the section of the flight envelope in which the aircraft 1 is flying.

The present invention may be embodied to overcome the above problems of complexity and increased weight of the main wings 3 by combining the functionality and reducing the complexity of the control systems and the number of control systems, which is particularly important in the foldable outboard portion 17 of the main wings 3. However, the control device of the invention can also be employed in other portions of the wings 3, or in wings 3 which do not have a foldable outboard portion 17, with the aim of reducing weight.

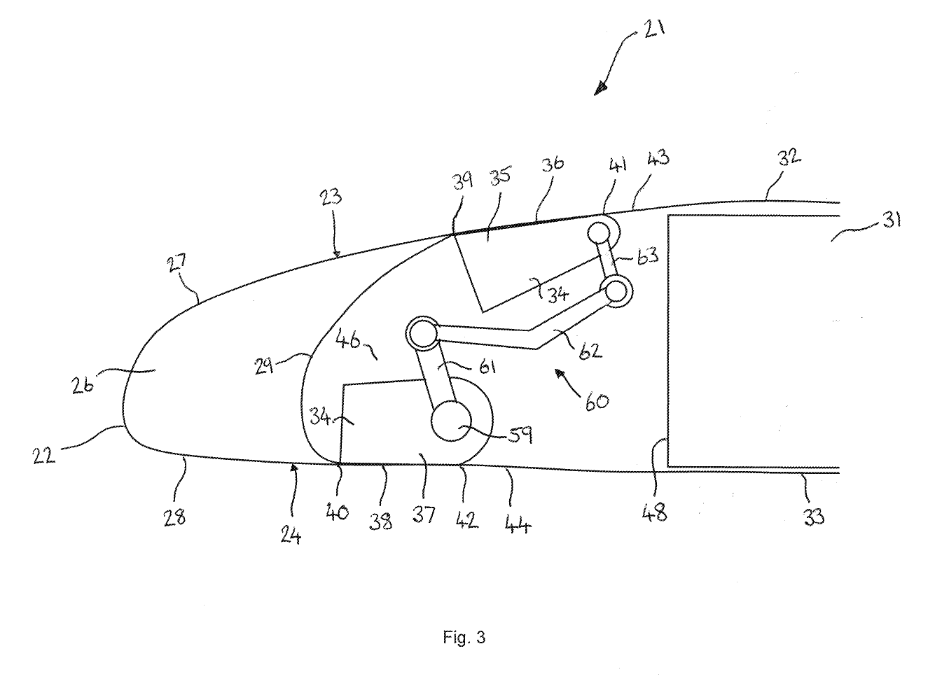

Referring now to FIG. 3, a wing assembly 21 for a leading edge portion of an aircraft wing 3, shown in FIG. 1, is shown. The wing assembly 21 is shown in its neutral position in which it has an aerofoil shaped cross-section with a leading edge 22 and a trailing edge (not shown in FIG. 3) which are connected by an upper surface 23 and a lower surface 24.

The wing assembly 21 comprises a leading edge slat 26 which extends in the spanwise direction. The leading edge slat 26 is the first part of the wing assembly 21 which airflow contacts during flight and comprises an upper surface 27 and a lower surface 28 which meet at the leading edge 22 of the wing assembly 21.

The upper surface 27 of the leading edge slat 26 forms a part of the upper surface 23 of the wing assembly 21. The lower surface 28 of the leading edge slat 26 forms a part of the lower surface 24 of the wing assembly 21. The leading edge slat 26 further comprises a rear surface 29 which connects the rearmost portions of the upper and lower surfaces 27, 28 of the leading edge slat 26.

The wing assembly 21 further comprises a wing structure 31 located rearward of the leading edge slat 26. The wing structure 31 comprises the load carrying wing structure which is not shown in detail. The load carrying wing structure may comprise spar and ribs in a traditional configuration.

The wing structure 31 is covered by an upper wing skin 32 and a lower wing skin 33. The wing skin 32 forms a part of the upper surface 23 of the wing assembly 21 and the lower wing skin 33 forms a part of the lower surface 24 of the wing assembly 21.

The wing assembly 21 further comprises a control device 34. The control device 34 comprises a movable upper spoiler 35 having an upper surface 36 and a movable lower spoiler 37 having a lower surface 38. The upper spoiler 35 is located in the top portion of the wing assembly 21 and the lower spoiler 37 is located in the bottom portion of the wing assembly 21 when they are in their neutral positions.

The upper surface 36 forms part of the upper surface 23 of the wing assembly 21 and the lower surface 38 forms part of the lower surface 24 of the wing assembly 21 when the upper and lower spoilers 35, 37 are in their neutral positions. That is, the upper spoiler 35 lies flush with the upper surface 23 in the neutral position and the lower spoiler 37 lies flush with the lower surface 24 in the neutral position. The upper and lower surfaces 36, 38 are shaped to substantially match the profile of the upper and lower surfaces 23, 24 of the portion of the aircraft wing 3 in which they are located.

The upper and lower spoilers 35, 37 are located upstream of the wing structure 31 and downstream of the leading edge slat 26. Therefore, the upper and lower spoilers 35, 37 are located between the leading edge slat 26 and the wing structure 31. When the upper and lower spoilers 35, 37 are in their neutral positions, the upper surface 36 is flush with the upper surface 23 of the wing assembly 21 and the lower surface 38 is flush with the lower surface 24 of the wing assembly 21 to form smooth aerodynamic surfaces.

In one embodiment, the upper and lower spoilers 35, 37 may also be adjacent to both the leading edge slat 26 and the wing structure 31. Upstream edges 39, 40 of the upper and lower spoilers 35, 37 may contact the rearmost portions of the upper and lower surfaces 27, 28 of the leading edge slat 26, respectively. Furthermore, downstream portions 41, 42 of the upper and lower spoilers 35, 37 may contact upstream portions 43, 44 of the wing structure 31.

The wing assembly 21 further comprises a cavity 46 which is formed between the leading edge slat 26 and the wing structure 31. The cavity 46 is defined between the rear surface 29 of the leading edge slat 26, a leading edge 48 of the wing structure 31, and the upper and lower surfaces 23, 24 of the wing assembly 21. In an embodiment, the leading edge 48 may be a spar of the wing structure 31.

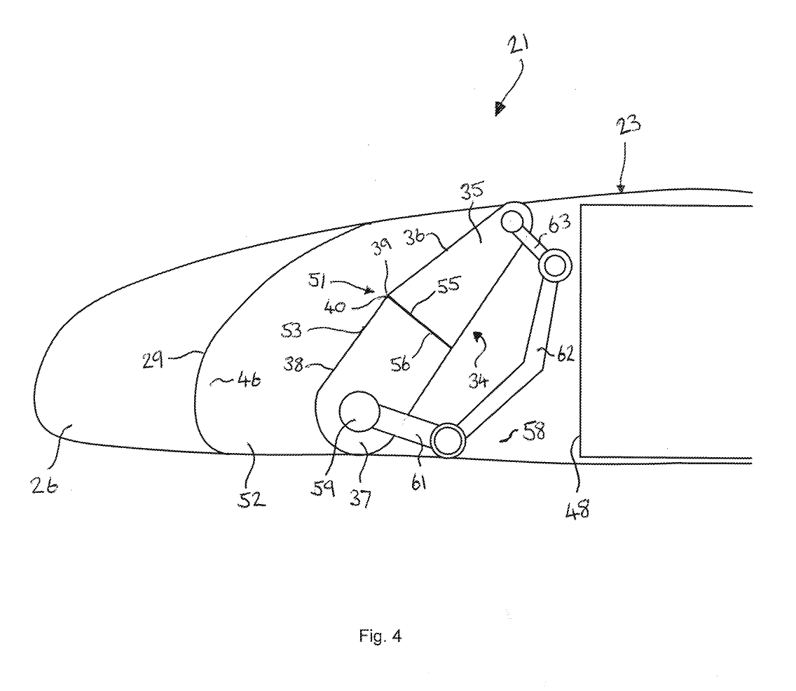

The upper and lower spoilers 35, 37 are configured so that the upper and lower surfaces 36, 38 can be moved from their neutral positions to a high lift enabled position, shown in FIG. 4, in which the upper and lower spoilers 35, 37 are moved into the cavity 46. Therefore, the first and second surfaces 36, 38 are within the neutral profile of the wing assembly 21. That is, the upper spoiler 35 extends below the upper surface 23 of the wing assembly 21 in the enabled position and the lower spoiler 37 extends above the lower surface 24.

The upper and lower spoilers 35, 37 are configured so that, when the upper and lower spoilers 35, 37 are in their enabled position, the wing 3 can assume a higher angle of attack, as an airflow slot 52 is formed from the cavity 46 behind the leading edge slat 26 for the aerodynamic flow of air to pass under the leading edge slat 26 and up through the airflow slot 52 and across the upper surface 23 of the wing 3. As the lift coefficient of an aircraft varies with angle of attack, a higher coefficient of lift is produced as a result of the higher angle of attack thereby enabling the aircraft to fly at slower speeds, or to enable it to take off and land in shorter distances. The function achieved by movement of the upper and lower spoilers 35, 37 into their enabled position is similar to the function achieved by the deployment of a conventional leading edge slat from the leading edge of an aircraft wing, as this also results in an airflow slot being created behind the slat for the purpose of increasing lift.

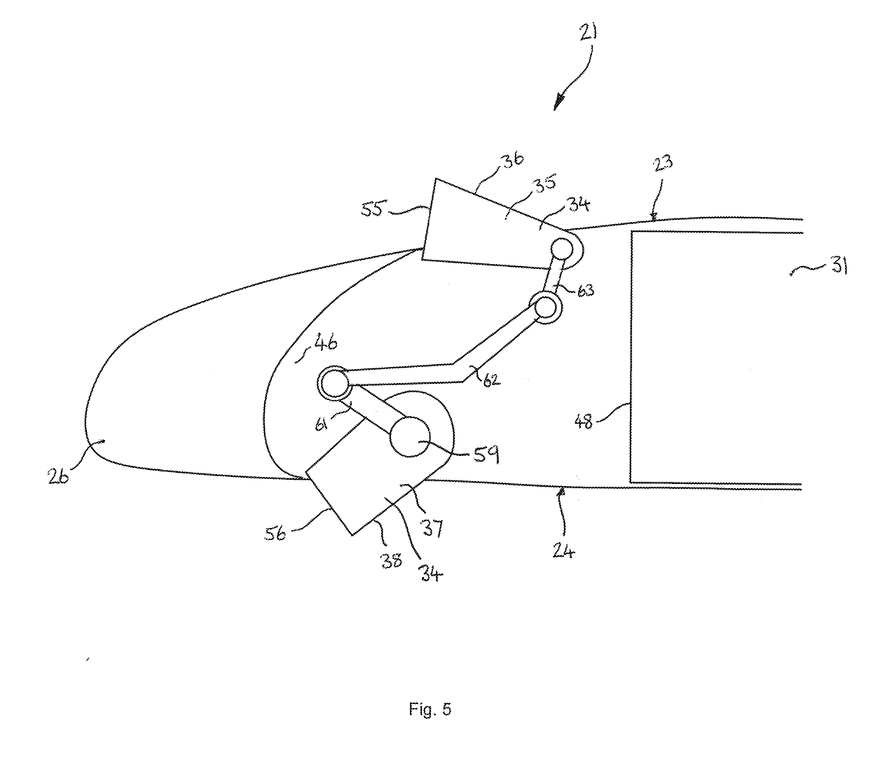

The upper and lower spoilers 35, 37 are also configured so that the upper and lower surfaces 36, 38 can be moved from their neutral positions to a deployed spoiler position, as shown in FIG. 5, in which the upper and lower spoilers 35, 37 are each moved partially out of the cavity 46. Therefore, the upper and lower surfaces 36, 38 are outside of the neutral profile of the wing assembly 21. That is, the upper spoiler 35 extends above the upper surface 23 and the lower spoiler 37 extends below the lower surface 24 when in the deployed position. In the deployed position, the lift component created by the wing 3 is reduced by creating a controlled stall over a portion of the wing 3 behind each of the upper and lower spoilers 35, 37.

The wing assembly 21 may further comprise an actuating mechanism which is configured to move the upper and lower spoilers 35, 37 between the neutral, high lift enabled, and deployed spoiler positions. The actuating mechanism may be located in the cavity 46 proximate to the wing structure 31.

A single actuating mechanism may be configured to move both the upper spoiler 35 and the lower spoiler 37. Therefore, the upper and lower spoilers 35, 37 are moved simultaneously. A single actuating mechanism may be used to minimize weight. In an embodiment, the actuating mechanism moves the upper spoiler 35 in the opposite direction to the lower spoiler 37 and may be geared so that the upper and lower spoilers 35, 37 arrive simultaneously at their enabled positions. However, it will be appreciated that, in other embodiments, each spoiler 35, 37 may have its own actuating mechanism so that each spoiler 35, 37 can be moved independently to the other spoiler 35, 37.

The actuating mechanism may be, for example, but not limited to a torque tube 59 mounted on the rotation axis of the lower spoiler 37 with a slave connection 60 linking the lower spoiler 37 to the upper spoiler 35, as shown in FIG. 3 to FIG. 5. The slave connection 60 comprises a first 61, second 62, and third 63 link. The first link 61 is fixedly mounted to the lower spoiler 37 and the third link 63 is fixedly mounted to the upper spoiler 35. The second link 62 connects the first link 61 to the third link 63. The second link 62 is allowed to pivot through a predetermined range relative to the first and third links 61, 63 so that the upper and lower spoilers 35, 37 can be moved from their neutral positions to their high lift enabled positions, shown in FIG. 4, and their deployed spoiler positions, shown in FIG. 5. The predetermined rotational freedom of the second link 62 mean that the upper and lower spoilers 35, 37 can arrive in their high lift enable positions simultaneously.

The upper and lower spoilers 35, 37 may be configured to be rotated between the neutral, low speed, high lift enabled, and deployed spoiler positions. Each of the upper and lower spoilers 35, 37 are rotatable in a direction towards each other into the aircraft wing 3 from their neutral positions to their low speed, high lift enabled positions. Furthermore, each of the upper and lower spoilers 35, 37 are also rotatable in a direction away from each other out of the aircraft wing 3 from their neutral positions to their deployed spoiler positions.

Each of said upper and lower spoilers 35, 37 may be pivotally mounted to the leading edge 48 of the wing structure 31 and extend in a direction towards the leading edge slat 26 when in their neutral and deployed positions. That is, the upper and lower spoilers 35, 37 are hinged at or proximate to their downstream portions 41, 42, i.e. proximate their trailing edges.

When the upper and lower spoilers 35, 37 are moved into their low speed, high lift enabled positions, shown in FIG. 4, the upper spoiler 35 is rotated anti-clockwise and the lower spoiler 37 is rotated clockwise. When the upper and lower spoilers 35, 37 are moved into their deployed spoiler positions, shown in FIG. 5, the upper spoiler 35 is rotated clockwise and the lower spoiler is rotated anti-clockwise.

Referring now to FIG. 4, the high lift and spoiler device 34 is shown with the upper and lower spoilers 35, 37 in their low speed, high lift enabled positions. When in this configuration the wing assembly 21 comprises a second leading edge portion 51 located behind and spaced from the leading edge slat 26. The second leading edge portion 51 is formed by the upper spoiler 35 and the lower spoiler 37.

The upper and lower spoilers 35, 37 are configured so that the upstream edges 39, 40 on the upper and lower surfaces 36, 38 contact each other so as to form an aerodynamic leading edge surface 53. In the present embodiment, the upper and lower surfaces 36, 38 substantially face the rear surface 29 of the leading edge slat 26 to form the airflow slot 52 between the leading edge slat 26 and the upper and lower spoilers 35, 37.

A contact surface 55 of the upper spoiler 35 may also be configured to abut a contact surface 56 of the lower spoiler 37. Therefore, the cavity 46 is spilt in two and forms a second, smaller cavity 58 and the airflow slot 52. The actuating mechanism may be located in the smaller cavity 58. In one embodiment, the inner surfaces of the first and second members 35, 37 may abut the leading edge 48 of the wing structure 31.

When the wing assembly 21 is in the configuration shown in FIG. 4, the leading edge slat 26 acts as a slat and the second leading edge portion 51 acts as the leading edge of the wing assembly 21. The airflow slot 52 allows air to flow between the leading edge slat 26 and the second leading edge portion 51 to help keep airflow over the upper surface 23 of the wing assembly 21 attached closer to the trailing edge (not shown). This allows the main wing 3 to operate at a higher angle of attack. Therefore, the aircraft 1 can generate a higher lift co-efficient and so can fly at lower speeds such as during landing.

In the present embodiment, the leading edge slat 26 is fixed in position. However, it will be understood that in alternative embodiments the leading edge slat may be movable to determine the size of the airflow slot 52 or change its angle of attack to improve performance. If the slat 26 is movable, then it may just pivot without extending laterally from the wing structure 31, as the mechanism for pivoting the slat 26 is much simpler than for extending it laterally away from the wing structure 31.

In an alternative embodiment, the upper and lower spoilers 35, 37 may abut the leading edge 48 of the wing structure 31 such that the aerodynamic leading edge surface 53 comprises the upper surface 36, the lower surface 38, and the leading edge 48.

When the control device 34 is in the configuration shown in FIG. 5, the leading edge slat 26 acts as the leading edge of the wing assembly 21. The upper and lower spoilers 35, 37 act as spoilers to reduce the lift generated by the wing assembly 21.

The upper and lower spoilers 35, 37 are located much further forward on the wing chord than conventional spoilers and are pivoted about the wing structure 31 so that the relatively blunt contact surfaces 55, 56 are moved directly into the airflow. In the present invention, the upper and lower spoilers 35, 37 are located at or proximate to the maximum thickness of the wing assembly 21. Therefore, the blunt contact surfaces 55, 56 are closer to the region of the aerofoil that generates the majority of the lift. This means that they are more effective at separating the airflow from the wing assembly 21 and at decreasing lift. Therefore, only a small deployment is required. The small deployment can also be effected quickly which is important for decreasing the load on the outboard portions 17 of the wings 3, shown in FIG. 1, during cruise.

Embodiments of the invention disclosed herein may be used on the inboard portion 18 of the main wing 3 but is particularly advantageous when the control device 34 is positioned in the foldable outboard portions 17 of the main wing 3 if such foldable outboard portions 17 are present. By employing the control device 34 in the outboard portions 17, the number of systems across the foldline (F) is reduced because the control device combines the slat and spoiler systems into one or reduces the complexity of the systems required to drive the slat 26 that cross the fold if, for example, the slat 26 is pivotable but is not required to extend laterally away from the wing structure 31.

Not only does the control device 34 reduce the complexity of the connection between the main wing 3 and its foldable outboard portions 17 but the control device 34 helps to reduce the weight of the main wings 3, irrespective of its position on the main wing 3, which in turn lowers fuel consumption. Therefore, aircraft 1 using the control device 34 are more efficient.

It will be appreciated that the wing assembly 21 comprising the control device 34 of the present invention may be incorporated into the main wings 3 of an aircraft 1 that does not comprise foldable outboard portions 17.

Furthermore, it will be appreciated that the wing assembly 21 comprising the control device 34 of the present invention may be incorporated into the main wings 3 of an aircraft 1 that comprises inboard portions 18 and outboard portions 17 that are foldable relative to the inboard portions 18. In such an aircraft 1, the wing assembly 21 comprising the control device 34 may be incorporated into either the inboard portion 18 or outboard portion 17 of the main wings 3 or into both.

In addition to the wing assembly 21 comprising the control device 34, other parts of the wing 3 may also be provided with conventional leading edge slats and spoilers. For example, if the wing assembly 21 is incorporated into the foldable outboard portion 17, the inboard portion may be provided with control devices of a conventional type.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The invention is:

1. A control device for an aircraft, the device comprising upper and lower spoilers mountable to a wing behind a leading edge slat, wherein each of said upper and lower spoilers are movable in a direction towards each other into a wing from a neutral position to an enabled position to form an airflow slot between the slat and said upper and lower spoilers.

2. The control device according to claim 1, wherein the upper and lower spoilers are configured to allow the wing to operate at a higher angle of attack when said upper and lower spoilers are in the enabled position.

3. The control device according to claim 1, wherein at least one of said upper and lower spoilers are rotatable in a direction towards the other of said upper and lower spoilers from said neutral position to said enabled position.

4. The control device according to claim 1, wherein each of said upper and lower spoilers are configured to contact each other in the enabled position.

5. The control device according to claim 4, wherein each of said upper and lower spoilers comprise a contact surface which are in contact while the upper and lower spoilers are in the enabled position.

6. The control device according to claim 1, wherein each of said upper and lower spoilers are movable in a direction away from each other out of a wing from said neutral position to a deployed position.

7. The control device according to claim 6, wherein the upper and lower spoilers are configured to reduce lift created by a wing when said upper and lower spoilers are in their deployed position.

8. The control device according to claim 4, wherein at least one of said upper and lower spoilers are rotatable in a direction away from the other of said upper and lower spoilers from said neutral position to said deployed position.

9. The control device according to claim 1, comprising an actuator assembly configured to drive each of said upper and lower spoilers.

10. A wing assembly for an aircraft comprising a wing structure, a slat extending from a leading edge of said wing structure and a control device according to claim 1 mounted to the leading edge of said wing structure behind said slat.

11. The wing assembly according to claim 10, wherein the slat is fixed in position.

12. The wing assembly according to claim 10, wherein each of said upper and lower spoilers are pivotally mounted to the leading edge of said wing structure and extend in a direction towards the slat when in the neutral and deployed positions.

13. The wing assembly according to claim 11, wherein the wing structure comprises an upper and lower surface and the upper spoiler lies flush with said upper surface in said neutral position.

14. The wing assembly according to claim 13, wherein the upper spoiler extends below said upper surface in said enabled position.

15. The wing assembly according to claim 13, wherein the lower spoiler lies flush with said lower surface in said neutral position.

16. The wing assembly according to claim 15, wherein the lower spoiler extends above said lower surface in said enabled position.

17. A wing for an aircraft comprising a wing assembly according to claim 10.

18. The wing according to claim 17, comprising an inboard portion and an outboard portion, the outboard portion being foldable relative to the inboard portion, wherein the wing assembly is located in the foldable outboard portion.

19. The wing according to claim 17, comprising an inboard portion and an outboard portion, the outboard portion being foldable relative to the inboard portion, wherein the wing assembly is located in the inboard portion.

20. An aircraft comprising a wing according to claim 17.

21. A wing assembly for an aircraft comprising:
a wing structure;
a leading edge slat mounted to a leading edge of the wing structure;
a control device between the wing structure and the leading edge slat, wherein the control device includes an upper spoiler and a lower spoiler, and linkages coupling the control device, the upper spoiler and the lower spoiler,
the control device configured to move the upper spoiler and a lower spoiler between a neutral position and a deployed position,
wherein the upper spoiler, while in the neutral position, has an upper surface bridging a gap between an upper skin surface of the leading edge slat and an upper skin surface of the wing structure,
wherein the upper spoiler, while in the deployed position, extends above the upper skin surfaces of the leading edge slat and the wing structure;
wherein the lower spoiler, while in the neutral position, has an lower surface bridging a gap between a lower skin surface of the leading edge slat and lower skin surface of the wing structure, and
wherein the lower spoiler, while in the deployed position, extends below the lower skin surface of the wing structure.
